(19) United States
(12) Patent Application Publication
(10) Pub. No.: US 2009/0207543 A1
(43) Pub. Date: Aug. 20, 2009

(54) SYSTEM AND METHOD FOR FAULT DETECTION AND HAZARD PREVENTION IN PHOTOVOLTAIC SOURCE AND OUTPUT CIRCUITS

(75) Inventors: Tony Boniface, Boulder, CO (US); Bryan Weitzel, Longmont, CO (US)

Correspondence Address: HOLLAND & HART, LLP, P.O BOX 8749, DENVER, CO, 80201, US

(73) Assignee: Independent Power Systems, Inc., Boulder, CO (US)

(21) Appl. No.: 12/338,740

(22) Filed: Dec. 18, 2008

Related U.S. Application Data
(60) Provisional application No. 61/028,630, filed on Feb. 14, 2008.

(51) Int. Cl. H02H 3/00

(52) U.S. Cl. 361/86; 361/90

(57) ABSTRACT

A fault detection system comprises a photo voltaic (PV) source responsive to incident sunlight to generate output power along output conductors. Control circuitry monitors to PV source and disables output power from the source in response to detection of a fault condition. The PV source may be situated on the roof of a structure and includes an array of modules. One or more controllers monitors the output of the PV modules and a combiner is electrically connected to an output of each controller for combining DC output power from the modules into a combined PV source power output. The combiner is capable of disabling the PV source power output upon detection of a fault condition by any of the controllers, and an override switch is preferably displaced from the PV source at a remote location. Methods for detecting fault conditions in a PV system are also provided and may entail monitoring conditions associated with the PV source and comparing the conditions to a set of known fault conditions associated with the source such that output power can be disabled when a detected source condition corresponds to a known fault condition.

### FIELD OF THE INVENTION

The invention relates to electronic detection and control systems, and more particularly concerns systems and methods for electrical fault detection and shock hazard prevention in photovoltaic (PV) systems.

### BACKGROUND

Conventional means of power generation and distribution rely on fuses and circuit breakers for protection against the hazards arising from overcurrent, fault, and arcing. An example of a potential common fault is a wire conductor causing a generator line-to-line short circuit, which upon removal of the short could cause an electric arc. Protection devices are typically disposed at or near the power supply generator to protect the conductors and loads of a distribution system against overcurrent and faults, and are typically accessible to maintenance, emergency, and other personnel with proper training. Unprotected circuits present both fire and shock hazards during overcurrent and fault conditions; thus, the National Electric Code (NEC) defines the standards and rules by which this protection must be implemented. NEC Article 690: “Solar Photovoltaic Systems” in particular addresses safety protocol for PV source circuits. This invention disclosure document addresses 2008 NEC standards and rules.

PV module sources have energy generating and internal impedance characteristics that make effective implementation of conventional means and methods of protection challenging. To date, appropriate devices for preventing fire and shock hazards are not commonly available for PV circuits. Metal conduit is frequently employed for preventing some hazardous conditions but no solution yet exists for all hazardous conditions. Fuses or circuit breakers at the PV source are required in some cases as a solution to certain fault conditions. However, the effectiveness of these protection devices is limited as they only clear under certain conditions, which may never occur due to the inherent characteristics of PV module sources. Moreover, these devices do not prevent or eliminate arcing in all cases, or the shock hazards resulting from various fault conditions including line-to-line and line-to-ground faults.

PV sources are further unique because they are powered by sunlight and as such are typically located on rooftops and other locations with limited accessibility. Due to this, homeowners, maintenance, and emergency personnel do not have a convenient means of disabling PV source outputs, which can be as high as 600 VDC, a potentially lethal voltage. While some local codes mandate the use of conventional disconnect switches on roofs, no code yet addresses the potential hazards arising from disconnect device inaccessibility, as in unusual cases such as a building fire, or extreme weather conditions.

Photovoltaic output circuits have characteristics very different from conventional sources of voltage generation or electrical supply such as generators or batteries. Conventional power generation sources typically employ fuses or circuit breakers to protect against potential hazards arising from overcurrent and faults. When a fault occurs, conventional protection means typically rely on the power generation source, or a stored energy supply, for the current needed to open or clear a protection device. Clearing the fuse or circuit breaker opens the supply conductors and de-energizes the PV output circuit conductors, thus preventing potential hazards. However, the current required, often for a short period of time, can be many times the rated current of the protection device. The power output of a PV source is limited by the amount of incident sunlight on the surface thereof, thus output power is variable between zero and the maximum limit reached at maximum sunlight intensity. To achieve maximum energy generation potential over time, the PV source must maximize absorption of all available sunlight and operate at its peak efficiency. Due to these described and other unique characteristics, wiring and protective fusing of a capacity capable of conducting these peak maximums without interruption must therefore be utilized in PV source systems. In a worst case situation, such as a short circuit when two power conductors of opposite polarity make contact, the PV current generated will only be slightly higher than normal maximum peak current. Thus, the protective device may not clear the short circuit fault.

A programmable smart detection device capable of sensing faults in the output conductors of a PV source circuit and reacting to stop the flow of power to the fault yet exists. Further, no device or system currently exists that allows personnel on the ground to disable a PV generating source at the actual source location on the roof via a readily accessible remote means. The resistance of the fault circuit determines the output voltage of the circuit. Under a low resistance line fault, the voltage will be as low as just a few volts, and the short circuit current a maximum for the given amount of sunlight. In the worst-case scenario, on a typical bright sunny day, this current could be between five and hundreds of Amps. When the conductors of the low resistance line fault are pulled apart, an electric arc can form and burn for a time and intensity dependent on the available current, voltage, distance apart, rate of separation, and ambient air conditions including humidity. Such electric arcs can burn green or blue depending on the metals of the conductors, and arc temperature can exceed the flash point of most materials, including metal conduit. As such, the potential of low resistance line-to-line faults for causing fires is high.

A typical electrical load for a PV source that generates a DC voltage is a special converter that is normally called an inverter. An inverter actually takes the available DC power and switches it so that the DC voltage is converted to an AC voltage at 60 Hz. Most conventional methods of ground fault protection in PV source circuits rely on the ground fault protection device (GFPD) disposed in the inverter or other electrical load. An inverter GFPD may react to a ground fault by disabling the inverter, halting processing, and delivery of power to the load, and disconnecting the internal bond of the grounded power conductor and the grounded system. In a ground fault case where either polarity output conductor contacts the equipment ground system, for example a grounded metal roof or conduit, the intentionally grounded conductor now becomes ungrounded due to the un-bonding action of the inverter GFPD. Conventional inverters may then display a warning message stating that the array is ungrounded, and dangerous voltages may be present. In practice, however, if resulting hazardous conditions do exist, a person that has not viewed the inverter display may not be aware of the shock hazard risk. For instance this may occur when a person standing on a grounded metal roof handles the conductor of a white or gray wire—which because of NEC color requirements they assume is grounded—then completes the circuit with the active PV source, thus subjecting the person to maximum voltages as high as 600 volts DC (VDC). This voltage far exceeds that typically present at residences with 120/240 volt AC service. These DC circuits pose a serious risk because the voltage does not alternate and the current never stops flowing, making physical release slower and more difficult, and the potential for electrocution very high.

Lack of a remote means of disabling a PV source at the source of generation is of particular concern to firefighters due to the shock hazards present when entering a building by invasive methods, such as by axes and chain saws. The risk of shock by high DC voltage during an invasive firefighting operation resulting from severing a metal conduit carrying live DC power from a PV source to a ground-based inverter thereof is high. The presence of excessive water in a firefighting operation has a negative impact on this risk. In light of the described and other known disadvantages of the conventional technology, improved systems and methods for detecting faults and preventing shock hazard in PV sources are desirable.

### SUMMARY

To address the aforementioned problems, devices, systems and methods are provided for detecting faults and preventing hazards in PV source and output circuits. An embodiment of this system comprises a programmable “smart” controller, a separate combiner for combining the outputs of a plurality of controllers, and a readily accessible manual switch in some remote location. Each of these three main parts is housed in weatherproof enclosures. The input of the controller is electrically connected to a PV generating source, such as a PV array comprised of one or more PV modules for generating DC power. Rack mounts or other suitable hardware or equipment for accommodating one or more PV modules are attached to a rooftop or other suitable location where the PV modules are exposed to optimum sunlight conditions. Preferably, the controller is disposed immediately adjacent to the PV source, and detects electrical faults throughout the DC circuits and conductors of the PV system. It is contemplated that the controller may incorporate calibration capabilities whereby, upon initialization, the controller characterizes its operating environment, such as input and output circuit impedances, voltage and current parameters, or any other desired electrical parameters. This can define a baseline against which future conditions can be compared. It is further contemplated that such calibration could also occur dynamically during use or selectively by a user when needed. Alerts could be sent based upon detected conditions, and these alerts may or may not result in disabling the PV source.

The output of the controller is optionally electrically connected to a combiner, which then connects to the remote, external manual switch. This switch then connects to the input of a power conditioning unit (PCU). A PCU is an electrical load that connects to some generating source and modifies or converts that source so that it can be used by some other load, such as an inverter, a charge controller, or other electrical equipment. The PV outputs power on the conductor wires connecting the PV source to the controller, combiner, manual switch, and PCU is continuously monitored by the controller.

Upon detection of any of a variety of fault conditions, the controller automatically renders the DC output voltage of the PV source safe. The manual switch of the system is readily accessible and disposed remote to the PV source. The input of the manual switch further receives output conductors from the controller. The manual switch is readily accessible and its output is electrically connected to a PCU or other electrical equipment. Thus, by means of intentional actuation of the readily accessible manual switch, the PV source may be disabled from a remote location. The manual switch may further serve as a DC disconnects means of the PV source conductors to the PCU or other electrical load. The manual switch serves to disable the PV source by creating a temporary short circuit condition on the output conductors that is detected at the controller disposed immediately adjacent to the PV source. Upon detecting this output short circuit, the controller immediately disables the PV source output, thereby removing any output circuit shock hazard. Thus, service or emergency personnel may then work anywhere on or around the controlled PV system and not have to worry about arc hazards or risking electrocution.

### BRIEF DESCRIPTION OF THE DRAWINGS

FIG. 1 shows an embodiment of an entire controlled PV system showing connections between the PV array, the controller, the manual switch, and a typical power conditioning unit (PCU). The optional combiner shown provides a means for connecting a plurality of controller outputs together in various serial, serial string, or parallel combinations;

FIG. 2 depicts a diagrammatic perspective view of a typical building and an embodiment of an entire PV system wherein a plurality of controllers is electrically connected and routed through a combiner to the manual switch located at ground level;

FIG. 3A is a diagrammatic plan view of a typical controller, comprising input connectors, such as MC connectors manufactured by Multi-Contact of Santa Rosa, Calif., a printed circuit board (PCB) comprising control switches and circuitry, and an output terminal block;

FIG. 3B is a diagrammatic perspective view of the controller of the system of FIG. 3A, comprising two MC input connectors, and a weatherproof enclosure with an attached cover;

FIG. 4A is a diagrammatic plan view of an embodiment of a manual switch;

FIG. 4B is a perspective view an embodiment of a manual switch, housed in a weatherproof enclosure with an attached cover;

FIG. 5A is a detailed plan view of an embodiment of a combiner;

FIG. 5B is a perspective view of an exemplary combiner, housed in a weatherproof enclosure with an attached cover;

FIG. 6 is a diagrammatic view of multiple PV array strings connected to a plurality of controllers and further connected to a combiner combining the controlled PV sources into one output;

FIG. 7 is a flowchart illustrating an internal decision-making process of a controller in one particular embodiment of a proposed method for the fault detection and hazard prevention in PV solar systems.;

FIG. 8 is a diagram showing typical voltages and currents as they is measured and monitored by an embodiment of a controller;

FIG. 9 is a block diagram view of an embodiment of a system for detecting electrical faults and preventing shock hazards in a PV source system, comprising an input from a PV module source connecting to the electronic control circuits of a controller, an optional combiner, and the remote manual switch;

FIG. 10 is a basic schematic representing one possible embodiment of the circuit design for a controller based on a programmable microcontroller;

FIG. 11 diagrammatically illustrates a representative fault condition where an output short circuit has occurred;

FIG. 12 diagrammatically illustrates another representative fault condition where a ground-fault has occurred near the PV array.

### DETAILED DESCRIPTION OF THE EXEMPLARY EMBODIMENTS

The following description is of the best-contemplated mode of carrying out the invention. This description is made for illustrating the general principles of the invention and should not be taken in a limiting sense. In the following description, reference is made to the accompanying drawings, which form a part hereof, and which show, by way of illustration, specific embodiments or processes in which the invention may be practiced. Where appropriate, the same or similar reference numerals are used throughout the drawings to refer to the same or like components. In some instances, numerous specific details are set forth in order to provide a thorough understanding of the present invention. The present invention, however, may be practiced without the specific details or with certain alternative equivalent devices and methods to those described herein. In other instances, well-known methods and devices have not been described in detail so as not to unnecessarily obscure aspects of the present invention.

Devices, systems and methods for detecting electrical faults and preventing shock and other hazards in PV source systems are disclosed. Preferred embodiments include a ‘smart’ controller disposed immediately adjacent to the PV generating source, and a readily accessible manual switch disposed at a remote location for disabling the PV source. The ‘controller’ comprises a programmable microcontroller integrated circuit (IC) and sensors that continuously monitor the PV source and output conductors, and upon detection of any of a variety of fault conditions, automatically disables the output power by shorting the PV source and opening the output power conductors of the controller. The output conductors from the controller feed into the manual switch located remote to the PV source, thus allowing the PV source and PCU input to be selectively disabled. The output of the manual switch feeds the PCU or other electrical equipment. In disabling the PV source power near the controller, potentially hazardous DC voltages are removed from the distribution wiring of the PV system. The controller can continuously turn on or pulse a transistor or other active device that is in parallel with the power output to short out and disable the output voltage, reducing it to a harmless low level. Subsequently the controller controls other devices, such as an electromechanical relay, disposed in series with the power output, opening up the output circuit of the ungrounded and/or grounded conductor. Upon removal of the detected fault condition, the controller is reset and it re-initializes to resume normal operation.

An embodiment of a method for detecting electrical faults comprises a computer algorithm directing a programmable microcontroller to continuously monitor input and output voltages and currents of PV source circuits, taking into account voltage and current variations due to external factors such as incident sunlight, temperature, and dynamic circuit and load parameters. It is determined a fault has occurred when a set of conditions is met, the conditions comprising abnormal combinations of input versus output voltage, current, and other contributing factors. The type of fault is determined by searching pre-determined and characterized fault conditions in a lookup table, database, or similar, stored in a memory. Fault conditions such as a short will be apparent due to abnormal combinations of measured voltage and current. In addition, the microcontroller continuously polls and monitors its plurality of digital inputs for any hardwired fault detection inputs, such as the enclosure cover sensor.

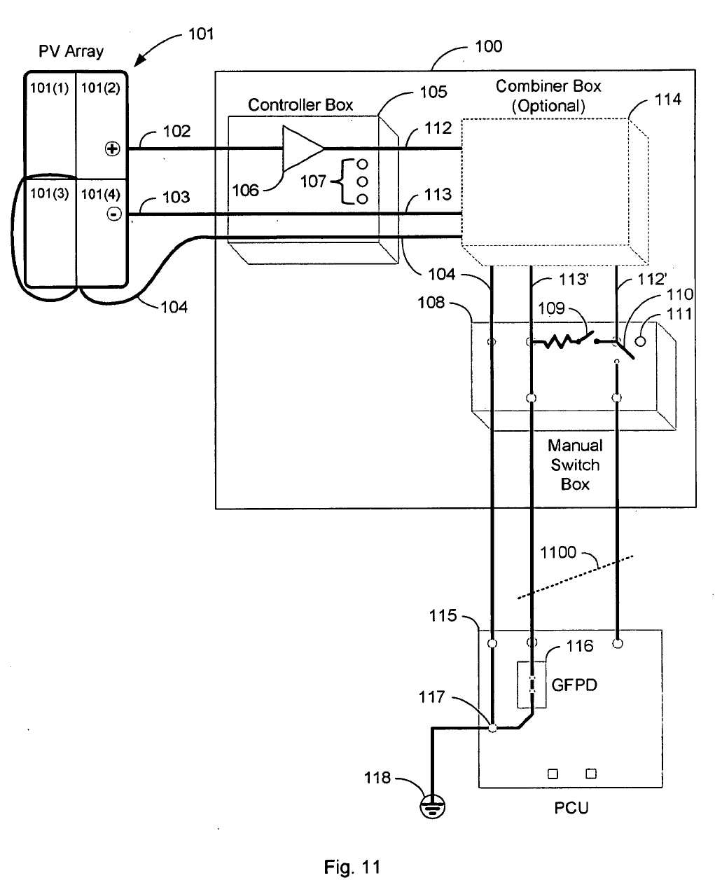

The microcontroller can search a database or lookup table comprising known fault conditions previously determined through empirical measurement methods, including observing PV source characteristics under faulted conditions with an oscilloscope, digital multimeter, data logger, or other test equipment. As the microcontroller continuously samples voltages and currents of source and output circuits, it can compare measured results against stored combinations of values, and analyze their dynamic response, i.e., the rate of voltage change and current change, which may represent specific faults. If a detected change has occurred and there is a close match to some known fault condition, the controller can then decide how to react, either by changing its status indicators, or by disabling PV source output power. As an example, take the case of some random conductor causing a line-to-line short circuit fault at the input to the PCU or inverter. The controller would detect that its output voltage has suddenly collapsed to a value that after comparisons is recognized as a short circuit. Depending on the nature of the short circuit fault and its duration, the controller output current would increase somewhat, but would be limited to the known short circuit current of the solar panel array. The controller quickly measures these changes and their rate-of-change, and responds accordingly. (see FIG. 11)

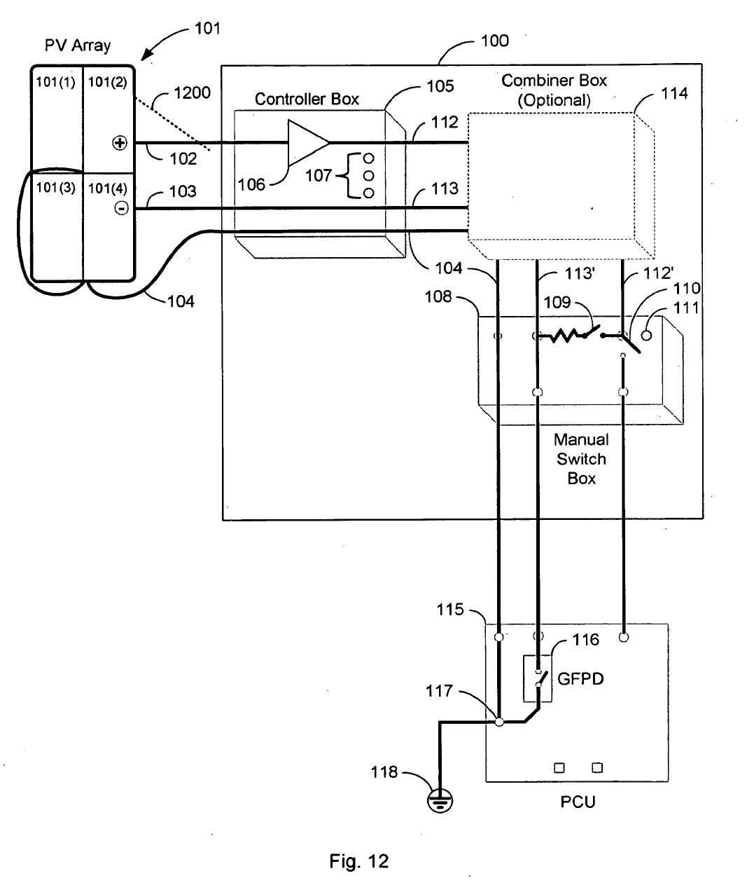

Another example would be a ground-fault that might occur in a PV installation on the roof of a building. In this case a conductor touches a bare uninsulated spot on an ungrounded output conductor and simultaneously touches an ECG such as the frame of the PV array. This would cause the GFCI or GFPD in the connected AC inverter to open up. This stops the flow of current, but it creates an extreme hazard in that the entire equipment ground of the system is now at the live output voltage of the array, which could be as high as 600 VDC. Thus, some person could then touch this live ground and a grounded conductor at the same time and receive a severe shock. The controller prevents this situation, however, because as soon as it detects that a ground-fault has occurred and the GFPD has opened, it turns on its shorting transistor and disables the PV array output voltage. (see FIG. 12)

Another feature of the controller is delineation between qualified electricians and non-electrician PV module installers. This is accomplished by providing foolproof, non-hardwire plug-in connectors on the PV installer side, and standard hardwire connections for electricians on the controller output side. The controller also has other internal safety features, such as an interlock switch that disables PV source power whenever the enclosure cover is open. The controller system may further comprise a manually-operated push-button or other switch with the purpose of testing the functions of internal or external GFPD circuits in order to meet existing safety standards.

When a solar array is working under normal circumstances significant current flows only when sufficient voltage is present. During a short, the voltage/current relationship is determined by the varying resistance, capacitance, and inductance characteristics of the short. The effect on the PV source output power is distinct and detectable. The speed and sampling rate of the microcontroller determine the minimum duration of a fault that can be detected and how quickly the controller can react.

Another approach for fault detection is programming an interrupt-driven microcontroller that is connected to external independent sensor circuits, and implementing a control algorithm that polls the microcontroller's interrupt inputs. The external voltage or current sensors have set range limits, and when tripped due to a fault condition, a digital output interrupts the microcontroller causing it to service the interrupt, check other measurements, and decide how to react.

The system may further comprise a multiplexing device or circuitry requiring a plurality of current sensors and switches, whereby series interconnections of the PV array may be dynamically reconfigured to optimize power output efficiency when a PV array is partially shaded. The multiplexing device may further comprise active switching capability for re-connecting PV modules of similar amperage output for significantly increasing efficiency in shaded PV module arrays. When a given series string of PV modules is partially shaded, the overall series string current output can be no greater than the lowest producing series PV module. The switching arrangement is advantageous in that the connections of various modules in the array may be reconfigured to put modules of like amperage in series with each other, thus maximizing the available output power.

A functional description and detailed listing of each numbered item shown in the block diagrams, overview drawings, and other figures is provided in the following. The block diagrams are intended to show the major components of the electronic design but not all of the detail at a schematic level. The PV modules shown may be connected in series, series string, parallel, or combined series/parallel configurations to achieve the desired DC output voltage.

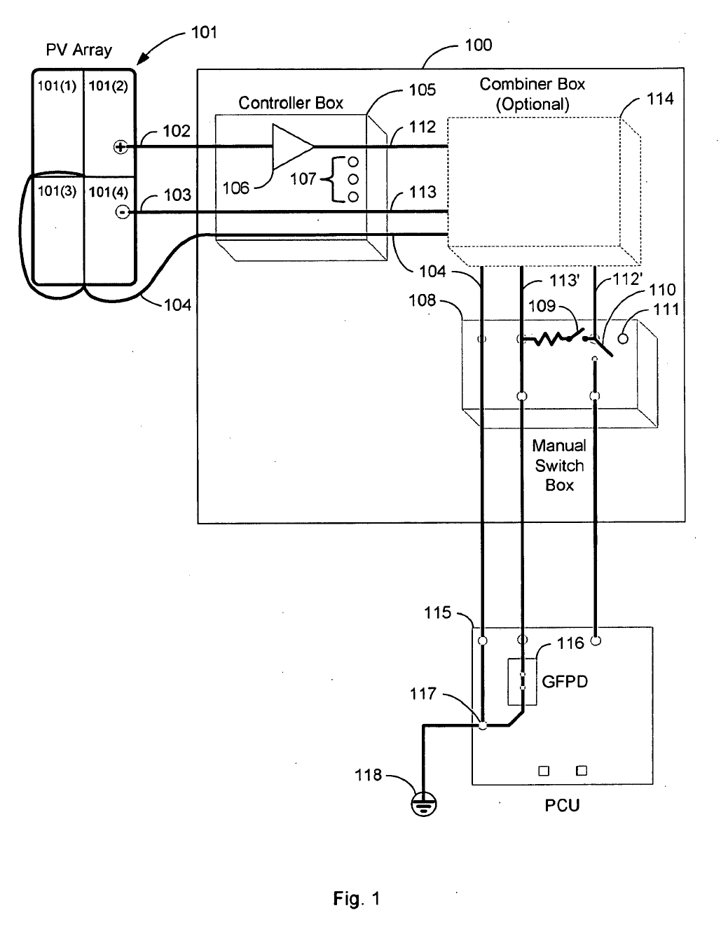

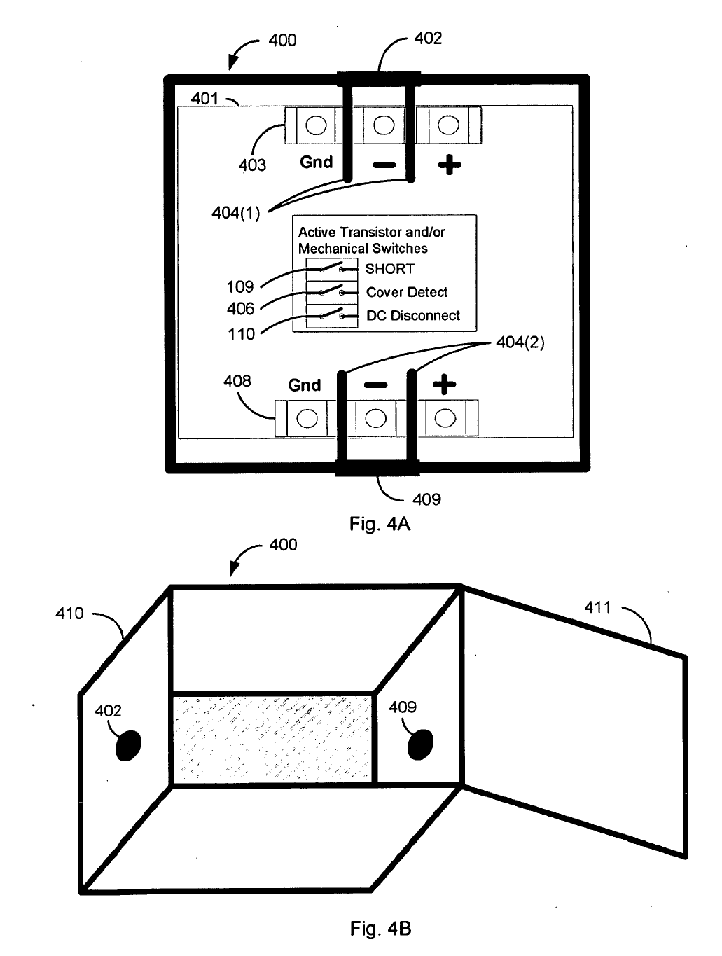

FIG. 1 is a block diagram view of an embodiment of a system showing connections between the PV source, the controller, the manual switch, and a typical PCU, in this case, an inverter. The complete PV control system 100 comprises controller 105, an optional combiner 114, the manual switch 108, and proper connective wiring. The optional combiner provides means for connecting a plurality of controllers together in various series, series string, or parallel PV module combinations. Modules 101(1) through 101(4) of the PV source define a PV array 101 that connects to the controller 105 via the PV source ungrounded (positive) wire 102 and PV source grounded (negative) wire 103 to appropriate input connectors, or by some other connection method, as would be known to those skilled in the art. For purposes of this disclosure the PV source can be considered as including components that are situated upstream of the controller. As such it is contemplated, for example, that components such as inverters, maximum power point tracking devices, or other types of power optimization devices, could be interposed between one or more modules of the array and the controller, yet still considered as part of the PV source. The equipment ground wire 104 connects the module frame members and racking system to the controller and the entire ground system. Preferably, the controller is located proximate to the PV source. As such, it may be at or near the PV source, or provided as a component of or more of the panels associated with the PV source. All of the above options are considered as being proximate. The three controller output wires 112′, 113′, and 104 connect the controller 105 to an optional combiner 114 or manual switch 108. The LEDs 107 and 111, or other display methods used to indicate the status of various electronic functions or fault conditions, may be common to all embodiments. Some operating or fault conditions might be indicated by combinations of lights, or by flashing lights. The triangular shape 106 represents the inherent switch or gate function of the system controller. As shown in FIGS. 1 & 4A, a switch 109 is used to trigger the controller, thus disabling the PV source output power. A series DC disconnect switch 110 is preferably also provided as shown in FIG. 4A. The enclosure 108 for the manual switch box includes a cover and houses the various switches and an indicator light 111 for indicating status of PV source output power.

The PCU 115 in this case has a built-in GFPD detector 116, and a ground connection, where the intentionally grounded PV source conductor 113′ and equipment ground 104 are bonded together at a single-point 117, then are physically connected to equipment or Earth ground 118 by a ground rod. 2008 NEC code allows ungrounded PV systems, thus some systems may not require a bonded ground wire connection. The optional combiner 114 may be used to connect multiple controllers in various series or parallel connection arrangements. The single combined output is then fed from combiner 114 to the manual switch 108. The output conductors of switch assembly 108 then feed into the PCU 115.

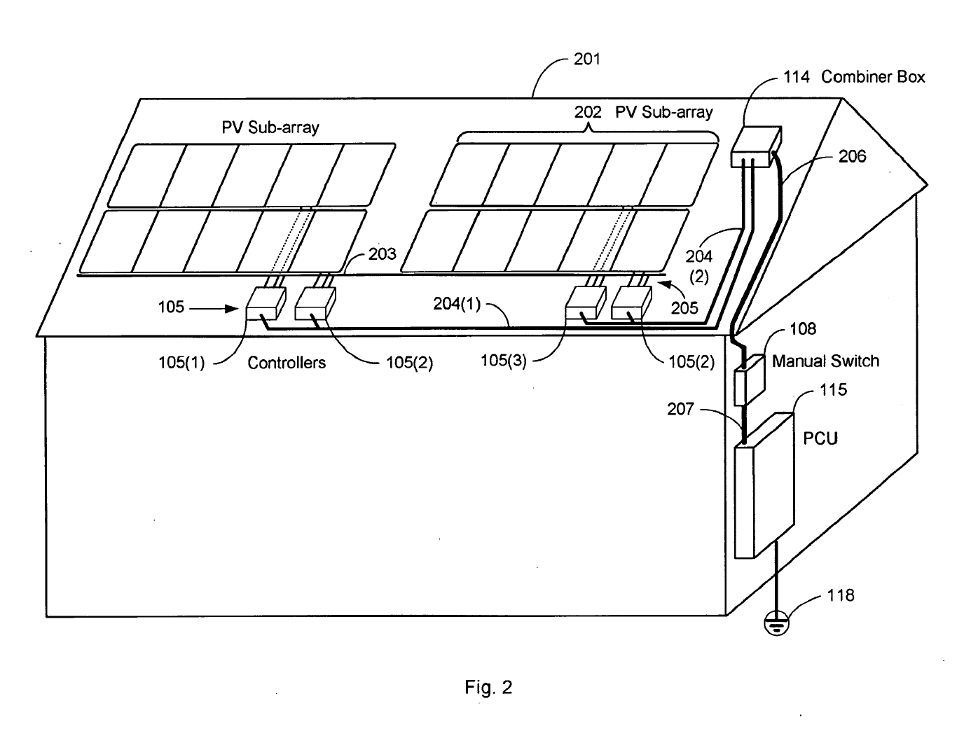

FIG. 2 is a diagrammatic perspective view of a typical building with a large rooftop PV system comprising a plurality of PV module strings or sub-arrays and their respective controllers, with their outputs combined in a combiner. The PV array, comprising PV module subarrays 202 and racking system 203, is shown in a typical location on building roof 201. The PV source ungrounded (positive) and PV source grounded (negative) conductors of each string and equipment ground wires 205 connect to controllers 105. The PV source conductors from the controllers feed into conduits 204. These conduits then feed all the array outputs into combiner box 114. The outputs are then connected as required in series or parallel arrangements in the combiner. A single output conduit 206 then feeds one set of wires into manual switch 108. Another conduit 207 then feeds the wires into a PCU 115. The entire system is connected per NEC protocol to the equipment or earth ground system, represented by electrical symbol 118.

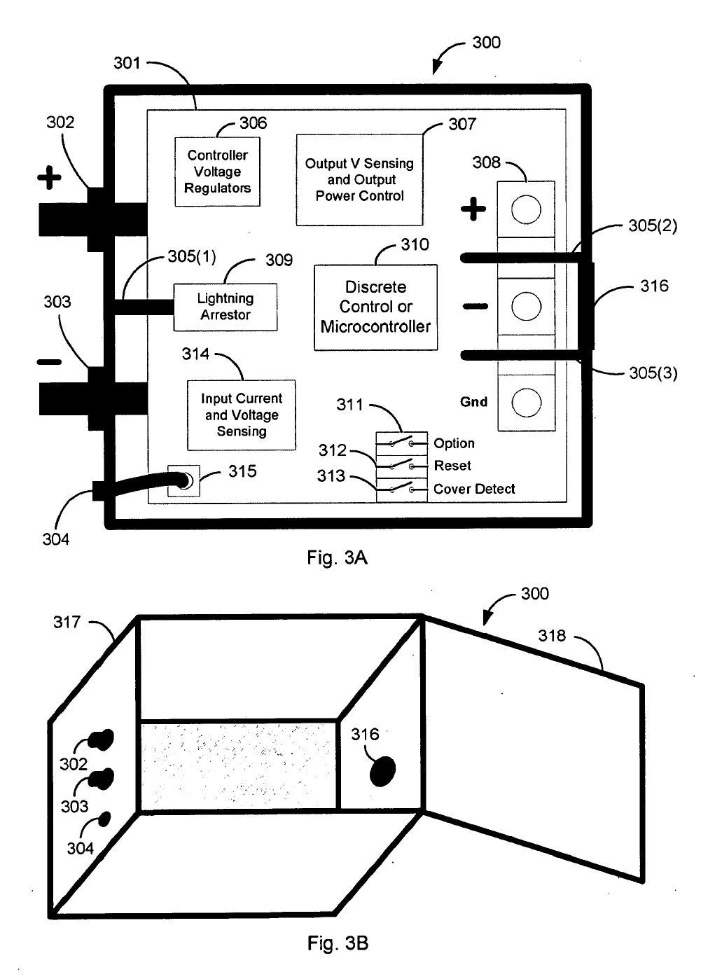

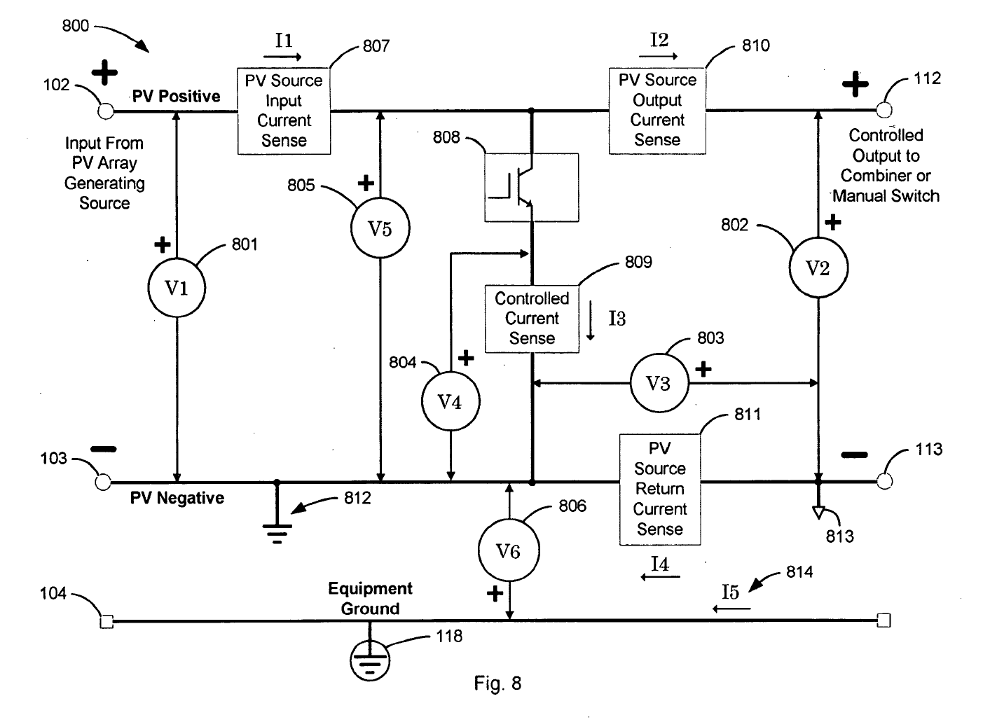

FIG. 3A shows a representative controller 105 with the minimum number of input connectors housed by a weatherproof enclosure. The enclosure 300 of controller 105 houses a circuit board 301 capable of accommodating all the necessary electrical and mechanical components. The female connector 302 connects to the ungrounded conductor wire connector from the PV source output (e.g., lead 102 in FIG. 1), while the male connector 303 connects to the PV grounded conductor output connector (e.g., lead 103 in FIG. 1). The equipment ground conductor wire (e.g., lead 104 in FIG. 1) connects to an external ground lug or enters the enclosure at 304 and connects to a screw terminal 315 on the circuit board or at a terminal strip, and is electrically connected to the circuit board 301. Sense circuits 314 for measuring the DC output voltage of the PV source and 307 for the output voltage of the controller may be provided in various key locations on the PC board, as discussed below with reference to FIG. 8, and are thus generically depicted as a box in FIG. 3A. There may be one or more independent voltage regulator circuits 306. The output control 307 preferably includes a series output relay, solid-state relay, or active transistor switching device(s), as well as one or more parallel switching devices and is controlled by the controller circuit 310 so as to either short out or disconnect the PV source output.

There may be several individual onboard switches, such as 312, for resetting the system after a fault has been detected and then cleared, and a switch 313 for detecting that the enclosure protective cover is fully closed. An optional switch 311 may also be provided for separately enabling or disabling the controller. A current sense transducer 314 for sensing PV source grounded return current is in series with the current returning to the PV source generator. Controlled output conductors connect to screw terminals of terminal block 308. Thick isolating barriers 305 in 3 positions provide insulation and separation between the connections. A sliding access cover for protecting personnel from shock hazard may be disposed in the enclosure 300, allowing only one polarity conductor to be accessed at a time, thus ensuring safety. A lightning arrestor 306 may also be provided either internally or externally of the device enclosure.

Any enclosures associated with the system can incorporate a mechanical switch for disabling live parts and, thus, the PV source when the door is opened without the need to communicate with the controller. As such the system could include mechanics for disabling the PV source irrespective of the operating condition of the controller. Alternatively, or in conjunction with such capabilities, operating condition sensors such as temperature, humidity, irradiance, pressure sensors and the like could be incorporated into enclosure(s) to transmit measured data to the controller for use by the controller in ascertaining existence or possible existence of faults or hazardous conditions.

FIG. 3B is a representative diagrammatic view of the weatherproof enclosure 300 of controller and comprises a box 317, an access panel (e.g. door) 318, input connectors 302, 303, and ground wire input 304 on one side. The three PV source output ungrounded, grounded, and equipment ground conductors exit on another side at opening 316.

FIG. 4A shows an embodiment of the manual switch assembly, such as 108 in FIG. 2. The weatherproof enclosure 400 of manual switch 108 comprises a circuit board 401 or other means capable of accommodating all required electrical and mechanical components. Suitable gauge input wires (e.g. wires 112′, 113′ & 104 in FIG. 1) connect at input terminal or connector 403. Output conductors connect at terminal or connector 408 on another side, then exit at opening 409. Thick isolation barriers 404 in four positions provide separation and insulation between all wire connections. The weatherproof enclosure 400 of manual switch 108 may comprise an interlock switch 406, such that the PV source is disabled whenever the cover 411 is open, thereby de-energizing all accessible terminals. Switch 109, in parallel with the input conductors, upon activation shorts the input conductors, thereby creating an intentional fault condition detected by the controller 105 in FIG. 1. The controller then de-energizes the PV source and output conductors. Manual switch 108 further comprises the optional series DC disconnect switch 110 (discussed previously) for opening the output conductors. In some embodiments, the functions of switches 109 and 110 may be combined into one switching device with a single actuator.

FIG. 4B is a representative diagrammatic view of the weatherproof enclosure 400 of the manual switch 108, comprising a box 410 with an access panel 411 (e.g., door), an opening 402 to receive the input conductors from the controller or combiner on one side, and an opening 409 for the three output conductors for PV source ungrounded (positive), PV source grounded (negative), and equipment ground on another side.

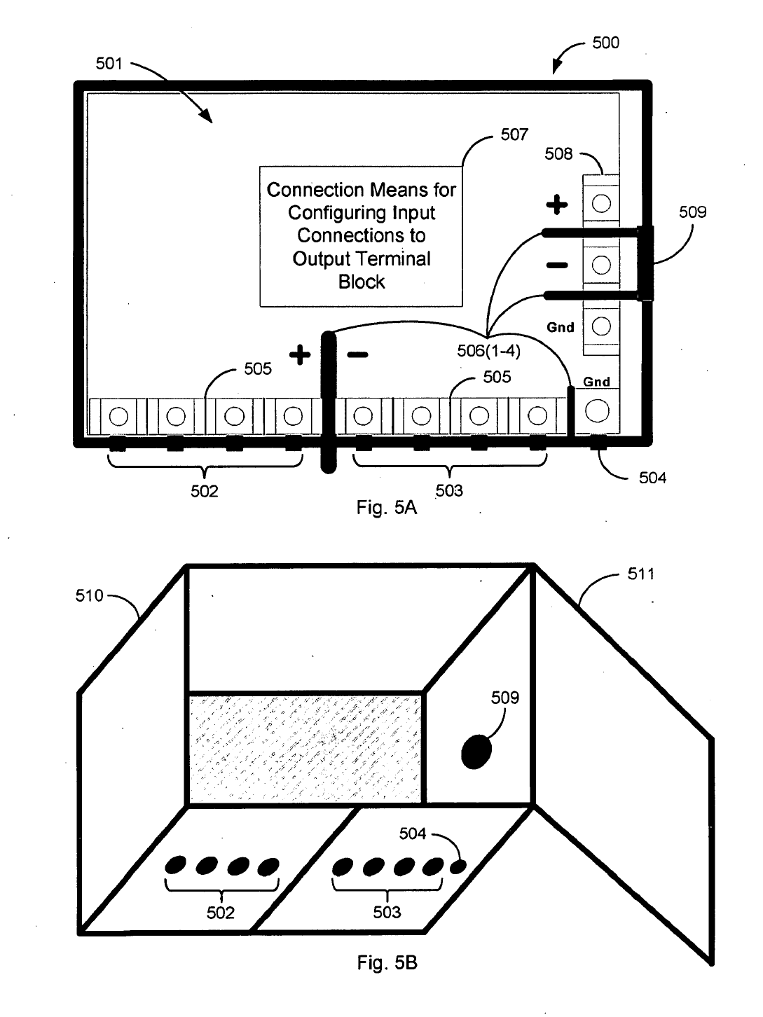

FIG. 5A is a plan view of an embodiment of a combiner 114, such as introduced in FIG. 1. The combiner, housed in weatherproof enclosure 500 comprises several input connectors, such as screw terminals 505 for bare wire ends, or standard MC connectors (not shown), depending on system requirements. This embodiment comprises four PV positive inputs 502 for connecting the ungrounded conductors, four PV negative inputs 503 for connecting the grounded conductors, and an input or external ground lug 504 for an equipment ground wire connection. Internal connection means 507 on a circuit board or other means 501 are provided for connecting inputs to outputs. The output conductors carrying the combined paralleled output current are connected at terminal 508, strain-relieved, passed out of the enclosure at 509, and fed via conduit to the manual switch 108. The isolation barriers 506 in four or more positions provide separation between ungrounded (positive), grounded (negative), and equipment ground connections.

FIG. 5B is a perspective view of an embodiment of a typical combiner enclosure 500. The weatherproof enclosure 500 comprises a box 510 with an access panel 511 (e.g. door), a plurality of input connections on a side, and a connection point for an output conduit on another side. The controlled PV source ungrounded conductors received at inputs 502 are kept separated and isolated from the controlled PV source grounded conductors received at inputs 503. The equipment ground conductor (EGC) either connects to an external ground lug or is received at input 504. The three output conductors for PV source ungrounded, PV source grounded, and EGC are strain-relieved and exit the enclosure 500 via opening 509 and are fed via conduit to the manual switch 108.

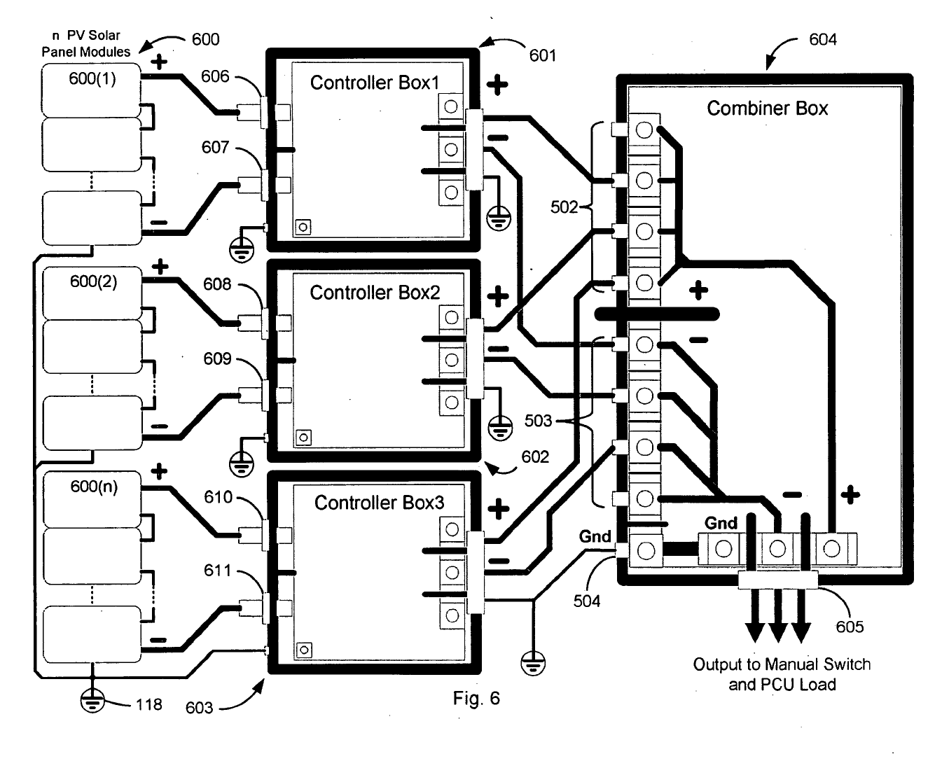

FIG. 6 is a connection diagram representatively showing a plurality of controllers connected to a single combiner box 604. Overall array 600 is a parallel arrangement of sub-arrays 600(1)-600(n), each of which has its associated PV modules connected in series. The series strings of PV array 600 connect to the PV source ungrounded (positive) input connectors 606, 608, 610, and PV source grounded (negative) connectors 607, 609, 611 of controllers 601, 602, and 603 respectively. The three controllers of this example are connected to an equal number “n” of PV modules in a string or sub-array, thus, each controller has essentially the same PV source output voltage as an input. The outputs of the controllers are connected in parallel in the combiner. All controlled PV ungrounded positive conductors are input at PV positive connections 502 and PV grounded negative conductors are input at PV negative connections 503. The common EGC input connection to the combiner enclosure is shown at 504, and may be an external ground lug. The combiner 604 then has a single group of one PV source ungrounded conductor, one PV source grounded conductor, and one equipment ground conductor (EGC) shown together at 605. The three combined conductors are then fed to the manual switch and PCU via a conduit.

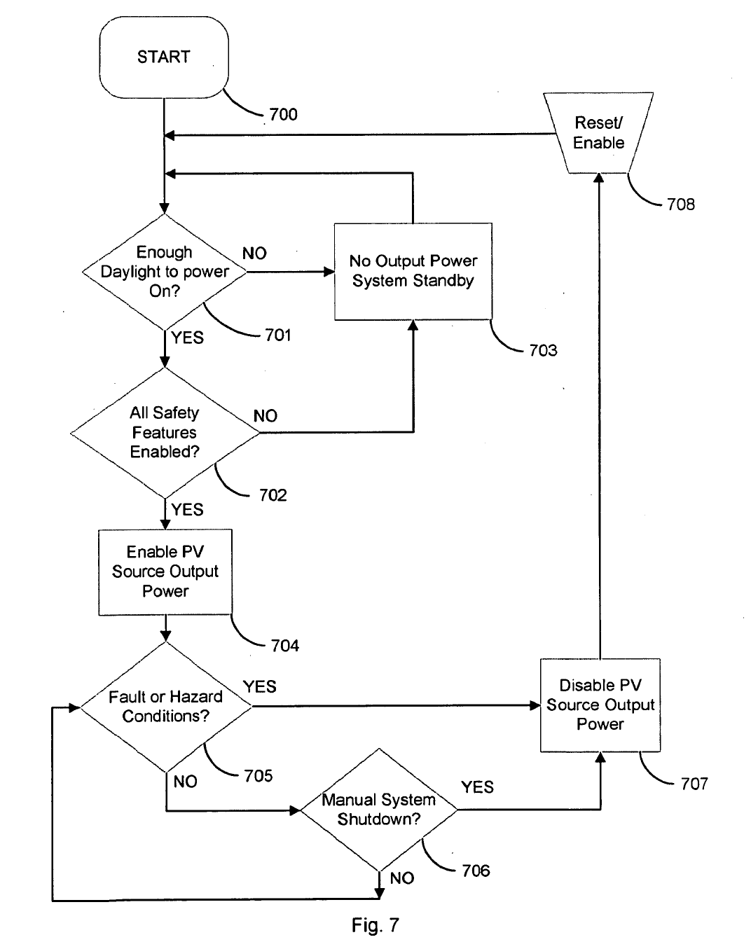

FIG. 7 is flowchart showing various input signals, decision-making processes, and outputs. This provides an exemplary high-level view of an algorithm of the microcontroller firmware, starting at 700. If a predetermined threshold level of sunlight is detected 701, which can be determined during calibration based on user's preferences, the controller checks the status of all the safety features 702, such as the open cover sensor and the presence of an untripped GFPD in the connected PCU load. If the system is not ready, it keeps the output power off and in standby mode 703. The inputs are continuously monitored until the system is ready and output power can be enabled 704. The controller then continuously monitors voltages and currents and determines when a fault occurs. If either a hazardous condition or fault is detected 705, or if the manual switch has been activated 706, then the controller immediately disables the PV source output power 707. The skilled artisan would recognize that control signaling for disabling the PV source could be provided over a selected transmission medium. That is, it could be transmitted through airborne signals (e.g., via RF), through cabling (e.g. CAT5), through power lines (e.g. BPL), or via smart grid, to name a few. As such, the signaling could be initiated locally or from a remote location over the selected transmission medium. When remote control signaling is used, the controller could be IP addressable through known means. Further, a specific control signaling could be used to disable the PV source irrespective of fault detection, for example, for any hazard prevention purpose or selectively at a user's discretion. When the fault has been cleared and the system has been manually reset at input 708, the algorithm returns to the start-up sequence.

FIG. 8 is a hi-level schematic diagram view of DC voltage and current monitoring in a controller, such as controller 105 in FIG. 1. The controller circuitry 800 comprises input and output connections and a circuit with measuring and control components (not shown). The inputs are connection 102 from the PV source output ungrounded connector from the PV array, and connection 103 from the PV source output grounded connector. Voltages are measured across two points in the circuit, and currents, indicated by numbered directional arrows, are either measured in series or derived from the voltages measured across the series sensors. The input voltage V1 801 represents the uncontrolled DC voltage output of the PV generated source, where V1 is the difference between PV source positive and negative. Voltage V2 802 is the voltage difference between the controlled PV source positive output 112 and PV source negative output 113. This is known as the controlled PV source voltage. The EGC connection 104 is for the controller equipment or Earth ground. The EGC current is not sensed or modified in the baseline design. Voltage V6 806 is the voltage difference between the equipment ground 118 and the controller internal circuit common 812. The PV source ungrounded negative return current I4 is derived from measured voltage V3 803 across the series current sense transducer 811, where I4=V3/R and R is the resistance of the current sense transducer or shunt. The PV source ungrounded input current I1 in transducer 807 represents the total output current of the PV array source, while current I2 in transducer 810 is the source current actually delivered to the combiner or manual switch and the PCU load. The current I3 in transducer 809 that is shunted by the power transistor 808 when it is turned on returns to the PV generating source via the grounded conductor. As these voltages and currents are monitored, the controller makes determinations about operating conditions and potential faults. The power switching device 808 is the power switching part of the output sensing and output power control, referenced above in FIG. 3A in block 307. As such, the circuitry of 307 represents all of the control and regulation of the PV source output voltage 802 as it is delivered to the PCU load.

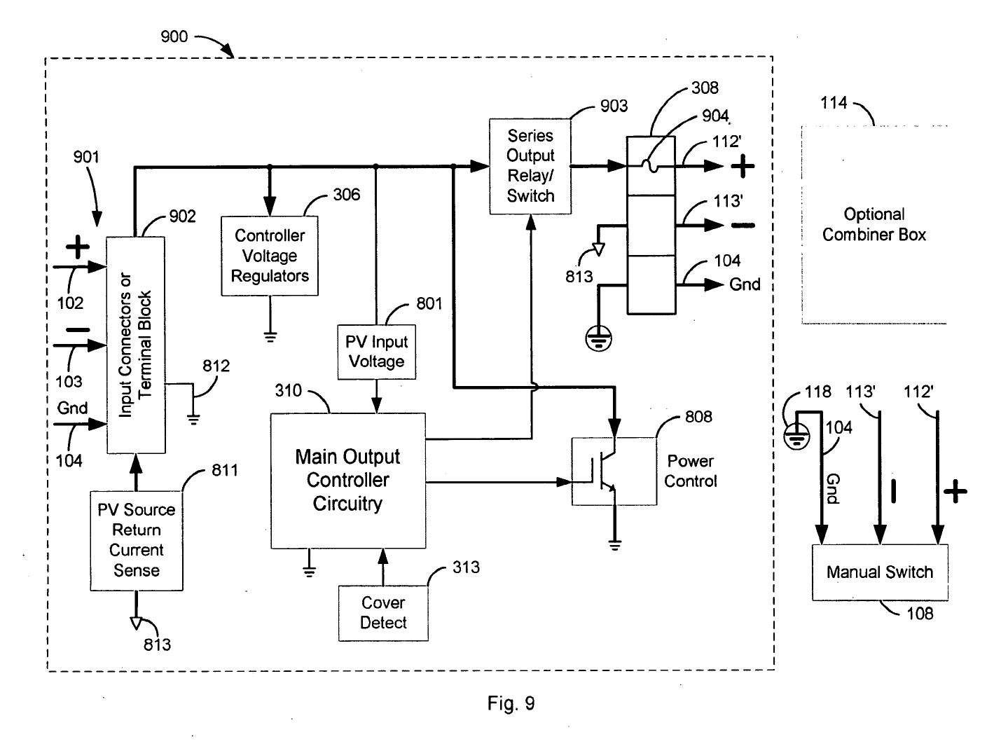

FIG. 9 shows a controller circuit in a generic block diagram view 900, showing control circuit features common to any embodiment, and the main input and output connections. The system receives a PV array source input from one or more PV modules with output 901. The output conductors of the PV module array 901 comprise male/female connectors, such as those manufactured by Multi-Contact (MC), for connecting to the female/male panel input connectors 902 of the enclosure of controller 105 in FIG. 1. The input connector 902 may alternately be a terminal block that accepts stripped ends of the strain-relieved PV source input conductors 901. Device 811 is a current sense transducer monitoring PV grounded negative return current I4 shown in FIG. 8, for sensing system source current returning from the PCU load through PV grounded negative conductor 113′ to the generating source at the PV array connection 901.

Separate adjustable or preset supply voltages, which power portions of the control circuitry, are generated in block 306, with controller circuit common 812. The PV source input voltage 801 is sensed by the main controller circuitry 310. The active semiconductor power-switching device 808 may be a Bipolar, MOSFET, or IGBFET transistor or other device serving to disable the power output by shorting the PV source input. To ensure that the output can still be disabled if the active device 808 fails open, a relay 903, or other switching device, is provided in series with the output and also controlled by main controller circuit 310. The active switch 808 or relay 903 may serve other control functions. Not shown in FIG. 9 is an optional series power switching device similar to 808 that would add the capability of opening the grounded conductor circuit that is shown by connection 813. The controller circuitry 310 comprises several signal inputs and outputs, one signal being from enclosure cover sensor 313, which indicates when the enclosure cover is open and directs the controller to disable the PV source output, thus providing a safety interlock function. Other potential manually-controlled switch inputs are not shown in this view. Optional series fuse 904 is located in series with the output of terminal block 308. The two controlled power output conductors 112′, 113′, and the ground wire 104 are connected to terminal block or connector 308, strain-relieved (not shown), and fed through a metal conduit to the optional combiner 114 or to the enclosure housing manual switch assembly 108. Manual switch enclosure 108 comprises one or more switches, which when manually activated cause controller circuitry 310 to trip, thereby disabling the PV source output power. The controller may further be programmed to reset automatically under certain circumstances, such as, after the cause of a fault has been cleared or physically removed. The embodiment of FIG. 9 may be optionally configured and programmed to provide a maximum power point tracking (MPPT) function to optimize PV power output as variations in daylight occur. Any embodiment may further comprise independent external sensors for monitoring PV module and/or ambient temperatures.

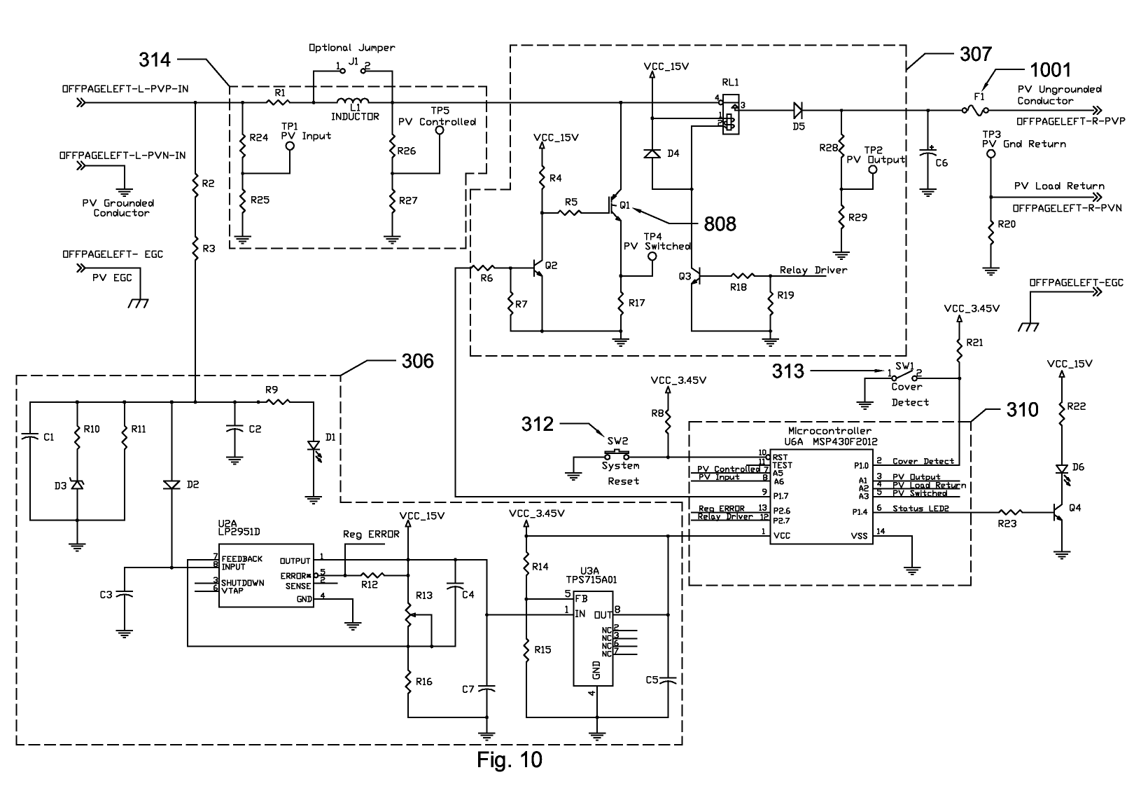

FIG. 10 is an exemplary schematic for a prototype version of the controller circuitry. Those skilled in the art would recognize that most of these components could take on many different values, and that this is not a final schematic.

The following describes the general operation of the circuit. The output power of the PV array would connect to the input circuit on the left side. One or more power resistors connect the input to three progressive DC voltage regulators, a zener diode-based regulator to limit the maximum voltage to 30V for example, then a 15 VDC regulator to power some of the device driver and LED display circuitry, and a 3.45 VDC regulator to run the low power microcontroller and other circuitry. There are filter and storage capacitors as part of the DC voltage regulation, as well as some bypass capacitors. There are also various resistors for voltage dividers, active circuit biasing, and other purposes.

The microcontroller 310 of FIG. 10 has four primary functions in this embodiment. It controls driver circuit 307 that functions to shunt or short circuit the output of the PV array source via device 808 and drive a circuit that controls a switching relay that is in series with the controlled voltage output. It also drives one or more LEDs used as status indicators. It also has a plurality of inputs to sense and monitor the voltages at several key points in the circuit, as defined previously in FIG. 8. Some of these voltages are divided down from the high DC voltages present in the circuit to a level that is suitable for the low voltage microcontroller, which in this case is using Analog-to-Digital converter (ADC) inputs.

The pushbutton switch 312 would be used to manually reset the controller after a fault has occurred and subsequently cleared or removed. Switch 313 represents a device that is used to detect that the controller cover is completely closed, thus allowing the output power to be enabled by the controller 310. Optional series fuse 1001 is located in series with the controlled output.

The following table shows the main components of the circuit for the schematic of FIG. 10. The component values listed are estimated and are subject to change.

| Component | | | Component | | |
|---|---|---|---|---|---|
| Ref. | | | Ref. | | |
| Designator(s) | Value | Comments | Designator | Value | Comments |
| R1, 17, 20 | 0.1 Ohm | Sense R | C1, 4 | 0.1 uF | |
| R2, 3 | 2.2k | 30 W | C2, 5 | 10 | |
| R4 | 220 | | C3 | 100 | |
| R5 | 49 | | C6 | 0.47 | |
| R6, 8, 21 | 47k | | C7 | 47 | |
| R7 | 22k | | L1 | Inductor | For V Boost |
| R9 | 1.2k | | D1, 6 | | Display LEDs |
| R10 | 20 | | D2, 4, 6 | | Rectifier |
| R11 | 15k | | D3 | | Zener |
| R12, 24, 26, 28 | 100k | | Q1 | | Power |
| | | | | | Transistor |
| R13 (Pot) | 100k | To set voltage | Q2, 3, 4 | | Switching |
| | | | | | Transistor |
| R14 | 1.5 M | | | | |
| R15 | 806k | | SW1 | | Pushbutton |
| R16 | 9.1k | | SW2 | | Lever |
| R18 | 5.1k | | | | |
| R19 | 33k | | U1A | LP2951 | 15 V Reg |
| R22 | 510 | | U2A | TPS715A | 3.45 V Reg |
| R23 | 6.8k | | U3A | MSP430 | Low-power |
| | | | | F2012 | microcontroller |
| R25, 27, 29 | 560 | | F1 | | Series fuse |

The remaining figures illustrate representative fault conditions which would be detectable by the invention. With initial reference to FIG. 11, a condition is demonstrated where some random conductor 1100 causes a line-to-line short circuit fault at the input to the PCU or inverter. The controller would detect that its output current 810 in FIG. 8 has suddenly increased some, while the output voltage 802 has suddenly collapsed to a value that it recognizes as a short circuit. The controller quickly measures these changes and their rate-of-change, and responds accordingly, turning on the shorting transistor 808 to disable the PV output power.

FIG. 12 shows another example condition where a ground-fault occurs in a rooftop installation of a building. A conductor 1200 touches a bare uninsulated spot on a PV ungrounded output conductor and simultaneously touches an ECG connected to conductor 104, such as a bare spot on the frame of the PV array. This would cause the GFCI or GFPD 116 in the connected PCU to open, creating an open-circuit in the ground connection. This stops the flow of fault current, but it creates an extreme hazard in that the entire equipment ground of the system is at the live PV output voltage of the array, which could be as high as 600 VDC. Thus some person could then touch this live ground 104 and a grounded conductor 103 or 113 at the same time and receive a severe shock. The controller prevents this situation however because as soon as it detects that a ground-fault has occurred and/or the GFPD has opened, it turns on its shorting transistor 808 and shorts out the PV array output power.

While certain preferred embodiments have been described and shown in the accompanying drawings, it is to be understood that such embodiments are merely illustrative of, and not restrictive on, the broad invention. Other embodiments that are apparent to those of ordinary skill in the art, including embodiments that do not provide all of the features and advantages set forth herein, are also within the scope of this invention. Further, it is to be understood that this invention is not limited to the specific construction and arrangements shown and described since various modifications or changes may occur to those of ordinary skill in the art without departing from the spirit and scope of the invention.

What is claimed is:

1. A fault detection system, comprising:
a. a photovoltaic (PV) source situated at a source location, said PV source responsive to incident sunlight to generate PV source output power along PV source output conductors; and
b. control circuitry monitoring conditions of said PV source, said control circuitry operative to disable output power from said PV source in response to detection of a fault condition.

2. A fault detection system according to claim 1 wherein said control circuitry is further operative to selectively disable output power from said PV source irrespective of existence of a fault condition.

3. A fault detection system according to claim 2 wherein said control circuitry is operative to disable said PV source in response receipt of control signaling.

4. A fault detection system according to claim 3 wherein said control signaling is generated from a remote location and transmitted over a selected transmission medium.

5. A fault detection system according to claim 1 wherein said control circuitry is located adjacent to said PV source.

6. A fault detection system according to claim 1 wherein said control circuitry compares detected conditions associated with said PV source to a set of known fault conditions for said PV source and disables said output power upon ascertaining that a detected condition corresponds to a known fault condition.

7. A fault detection system according to claim 1 wherein said control circuitry includes a manual override switch situated at a location that is remote from said PV source.

8. A fault detection system according to claim 1 wherein said control circuitry includes a plurality of sensors for detecting environmental conditions associated with the system.

9. An electrical fault detection system, comprising:
a. a photovoltaic (PV) source situated at a source location, said PV source responsive to incident sunlight to generate PV source output power along PV source output conductors; and
b. control means for monitoring conditions of said PV source and disabling output power from said PV source in response to detection of a fault condition.

10. An electrical fault detection system, comprising:
a. a photovoltaic (PV) source situated at a source location, said PV source including a solar panel array responsive to incident sunlight to generate PV source output power along PV source output conductors;
b. a manual override switch electrically displaced from said PV source at a remote location, said manual override switch movable between a switch normal state and a switch override state; and
c. a controller located adjacent to said PV source and electrically interconnected between the output conductors and said manual override switch, said controller for monitoring conditions of said PV source and operative to disable said PV source in response to detection of a fault condition.

11. An electrical fault detection system according to claim 10 wherein said PV source is situated on a rooftop and said manual switch is displaced from the rooftop at a remote location.

12. An electrical fault detection system according to claim 10 wherein movement of said manual override switch to the switch override state corresponds to a known fault condition and causes said controller to disable said PVC source.

13. An electrical fault detection system according to claim 10 wherein movement of said manual override switch to the switch override state creates a short circuit condition that is detected by said controller as a fault condition.

14. An electrical fault detection system according to claim 10 wherein said controller re-enables said PV source once said fault condition is removed.

15. An electrical fault detection system according to claim 10 wherein said controller includes a programmable microcontroller.

16. An electrical fault detection system according to claim 15 wherein said microcontroller resets and re-initializes the system once the fault condition is removed.

17. An electrical fault detection system according to claim 10 including a plurality of sensors for detecting environmental conditions associated with the system.

18. An electrical fault detection system according to claim 17 wherein said plurality of sensors is selected from a group consisting of at least one sunlight sensor, at least one temperature sensor, at least one dynamic circuitry and load parameter sensor, and at least one hard-wired fault detection sensor.

19. An electrical fault detection system according to claim 10 wherein said controller continuously monitors I/O voltages and currents associated with said PV source.

20. An electrical fault detection system, comprising:
a. a structure having a roof,
b. a photovoltaic (PV) source situated on said roof at a source location, said PV source including an array of PV modules each responsive to incident sunlight to generate output power along respective output conductors;
c. a plurality of controllers each monitoring the output conductors of a respective one of said PV modules;
d. a combiner electrically connected to an output of each controller for combining DC output power from said PV modules into a combined PV source power output; and
e. an override switch electrically displaced from said PV source at a remote location that is not on said roof, said override switch movable between a switch normal state and a switch override state, wherein said combiner is capable of disabling said PV source power output upon detection of a fault condition by at least one of said controllers.

21. An electrical fault detection system according to claim 20 including a programmable control unit (PCU) connected to said override switch for interfacing said PV source to a load.

22. An electrical fault detection system according to claim 21 wherein movement of said override switch to the switch override state causes said controller to disconnect said PV source from the load.

23. An electrical fault detection system according to claim 20 wherein said controllers and said switch are each housed in a respective weatherproof enclosure, each said enclosure including an operating condition monitoring sensor.

24. An electrical fault detection system according to claim 23 wherein said controller is operative to detect existence of a potential fault condition should any said operating condition monitoring sensor indicate that a door to its respective weatherproof enclosure is open.

25. A method of detecting faults conditions in a photovoltaic (PV) system, comprising:
a. providing a photovoltaic (PV) source situated at a source location, said PV source responsive to incident sunlight to generate PV source output power along PV source output conductors;
b. monitoring conditions associated with said PV source;
c. comparing detected PV source conditions to a set of known fault conditions associated with said PV source, wherein said set includes at least one fault condition; and
d. disabling output power of said PV source upon ascertaining that a detected PV source condition corresponds to a known fault condition.

26. A method according to claim 25 further comprising disabling output power of said PV source proximate to said PV source output conductors.

27. A method according to claim 25 comprising pre-determining said set of known fault conditions prior to normal operation of said PV system.

28. A method according to claim 25 whereby one of said known fault conditions is a line-to-line fault.

29. A method according to claim 25 whereby one of said known fault conditions is a ground-fault.

30. A method according to claim 25 comprising disabling output power of said PV source in response to activation of a manual override switch.

31. A method according to claim 30 comprising manually resetting the system after a detected fault condition has been removed.

32. A method according to claim 25 comprising electronically resetting and reinitializing the system once a detected fault has been removed.

33. A method of detecting faults conditions in a photovoltaic (PV) system, comprising:
a. providing a photovoltaic (PV) source situated at a source location on a rooftop, said PV source responsive to incident sunlight to generate PV source output power along PV source output conductors;
b. pre-determining a set of known fault conditions for said PV source prior to normal operation of said PV system, wherein said set includes at least one fault condition;
c. enabling PV source output power;
d. monitoring conditions associated with said PV source during normal operation;
e. comparing detected PV source conditions to said set of known fault conditions; and
f. disabling output power of said PV source upon ascertaining that a detected PV source condition corresponds to a known fault condition.

34. A method according to claim 33 comprising placing said PV source in standby mode if there is insufficient available sunlight.

35. A method according to claim 33 further comprising disabling output power of said PV source on the rooftop proximate to said PV source output conductors.

36. A method according to claim 33 comprising disabling output power of said PV source in response to activation of a manual override switch.
